(19) United States
(12) Patent Application Publication
(10) Pub. No.: US 2012/0102764 A1
(43) Pub. Date: May 3, 2012

(54) Puncture Device for Blister Pack Medicine

(76) Inventor: Henry Rogers, Medford, OR (US)

(21) Appl. No.: 12/915,720

(22) Filed: Oct. 29, 2010

(51) Int. Cl. B26F 1/32

(52) U.S. Cl. 30/358

(57) ABSTRACT

The present invention is directed to a blister pack opener for a soft pack of individually segregated unit dosages of medication. It is a strip of spring steel (or other material) that forms a “V”. An orifice in the lower portion of the “V” receives the unit dosage section of the soft pack commonly referred to as the “blister”. The blades that puncture the paper and foil backing protecting the medication are in the upper portion of the “V”. When the blister is placed within the orifice and the top section with the blades is moved fully down, the paper/foil barrier is punctured on three sides allowing the medication to be hand pushed from the blister. The paper flap that results over the empty blister allows used medication, in the case of nicotine gum, to be hygienically disposed of. Smaller medication blisters, like those used for antihistamines, can be opened by placing the blister in the orifice, pulling the blister full forward and puncturing one side of the paper/foil barrier by moving the bade portion fully downward. The smaller medication can then be forced through the interrupted barrier by hand.

### REFERENCES CITED

| | | | |
|---|---|---|---|
| 4,384,649 | May 24, | 1983 | Bodsky |
| 4,909,414 | Mar. 20, | 1990 | Heath |
| 5,356,010 | Oct. 18, | 1994 | Weinstein |
| 5,431,283 | Jul. 11, | 1995 | Weinstein, et. al. |
| 5,722,563 | Mar. 03, | 1998 | Hunts |
| 5,791,513 | Aug. 11, | 1998 | Intini |
| 5,853,101 | Dec. 29, | 1998 | Weinstein |
| 7,175,044 | Feb. 13, | 2007 | Benktzon, et. al. |

### BACKGROUND OF THE INVENTION

1. Field of the Invention

The present invention is directed to accessing soft-pack medication by cutting the barrier paper and foil to allow the user to easily press the medicine from the type of medical container known as a blister pack. For medicines such as nicotine gum, the paper foil barrier is cut on only three sides and allows the used medicine to be disposed of hygienically.

2. Information Disclosure Statement

Many medicines are now packed in blister packaging that allows individual dosages to be expelled from the blister. Initially the barrier to the medicine was a thin foil or paper covering and it was easy to expel the dosage. Child proofing this medicine has required that a heavier barrier be added, generally, atop the former barrier. Consequentially, this new packaging has made it difficult for all users to access their medication.

Several patents have emerged to resolve the difficulty of expelling a dose of medicine from the new blister packs. Many involve a push out mechanism which acts atop the blister and forces the dose through the barrier. An example of this method is U.S. Pat. No. 5,791,513 issued to Thomas D. Intini. But with all such devices, a rod or plunger exerts extreme force on the medication as it is expelled and can cause a pill to crush or crack or a gel pack to rupture. Damaged medication can cause unintended results such as a delayed action medication going into the user's system more quickly.

U.S. Pat. No. 4,384,649 was issued to Louis Brodsky. The device described cuts the medication from the blister pack but could require many configurations, is relatively cumbersome to use, requires a large force for the new packaging and could be expensive to produce.

U.S. Pat. No. 4,909,414 was issued to Clarence Heath. The device described forces the blister pack against a blade that planes the protective barrier from the pack. The device could prove dangerous, cause contamination of the medication, expose more dosages than needed, and prove expensive to construct.

U.S. Pat. No. 5,356,010 was issued to Jack Weinstein. The device was a box with a simple hinged cutter that requires individual doses of medicine to be separated from a sheet of medication, inserted in the cutter, and cut. This device could prove cumbersome because dosages are difficult to separate from the new packaging, the blisters vary in size which could cause difficulty in fitting the cutter, and the device could prove expensive to manufacture.

U.S. Pat. No. 5,431,283 was issued to Jack Weinstein, et. al. The device consists of a box that contains a cutter that acts on the backing barrier of a blister and forces the dosage against a rod that supports the medicine while the cutter cuts the backing. This device would require a different configuration for every shape of blister and, given the hinged construction of the box, could prove expensive to produce.

U.S. Pat. No. 5,722,563 was issued to Larry D. Hunts. The device is a push out type as mentioned above but is in the shape of a pliers with a ram in the upper portion that forces the medication through the barrier and into a catch cup. Again, this type of mechanism, given the strength of the new blister pack barriers, can cause damage to the dose. The device further requires templates of different shaped orifices to accept various shaped blisters and could prove difficult to use and expensive to manufacture.

U.S. Pat. No. 5,853,101 was issued to Jack Weinstein. The device requires that an individual blister be inserted into a track and a hinged lid with a cutter lowered on the backing to cause perforation. Such a hinged device could prove expensive to manufacture and positioning of the blister could prove difficult since vision is obscured when the hinged lid is lowered.

U.S. Pat. No. 7,175,044 was issued to Maria Benktzon, et. al. The device is a box that carries an entire sheet of blisters. The sheet is removed and a push out mechanism built into the box expels a dosage through the barrier paper when it is required. Again, push out devices can crack or break medicines because of the toughness of the new backing materials.

The present invention accomplishes allowing the user to easily puncture the backing of individual blister pack dosages by providing good vision and feel for the location of the medicine. It will not fracture, crack or contaminate the medicine. For products such as nicotine gum, the backing remains as a flap connected to the blister and allows for hygienically disposing of a used medicine. Furthermore, the present device would be very economical to manufacture. In view of the prior art, the present device is neither taught nor rendered obvious.

### SUMMARY OF THE INVENTION

The present invention is directed to a blister pack opener for a soft pack of individually segregated unit dosages of medication. It is a strip of spring steel (or other material) that forms a “V”. An orifice in the lower portion of the “V” receives the unit dosage section of the soft pack commonly referred to as the “blister”. The blades that puncture the paper and foil backing protecting the medication are in the upper portion of the “V”. When the blister is placed within the orifice and the top section with the blades is moved fully down, the paper/foil barrier is punctured on three sides allowing the medication to be hand pushed from the blister. The paper flap that results over the empty blister allows used medication, in the case of nicotine gum, to be hygienically disposed of. Smaller medication blisters, like those used for antihistamines, can be opened by placing the blister in the orifice, pulling the blister full forward and puncturing one side of the paper/foil barrier by moving the bade portion fully downward. The smaller medication can then be forced through the interrupted barrier by hand.

### BRIEF DESCRIPTION OF THE DRAWINGS

The present invention is easily understood when the specification is compared to the drawings presented here.

FIG. 1 shows the entire “V” shaped device with the blade side and orifice side identified.

FIG. 2 shows the side view with the device at rest or “open.”

FIG. 3 shows the device “closed” and one can see that when a blister is resting in the orifice, the blades go through the backing and into the orifice and, thus, into the blister. The three blades cause slits in the backing that allow the dosage of medicine to be easily expelled.

### DETAILED DESCRIPTION OF THE INVENTION

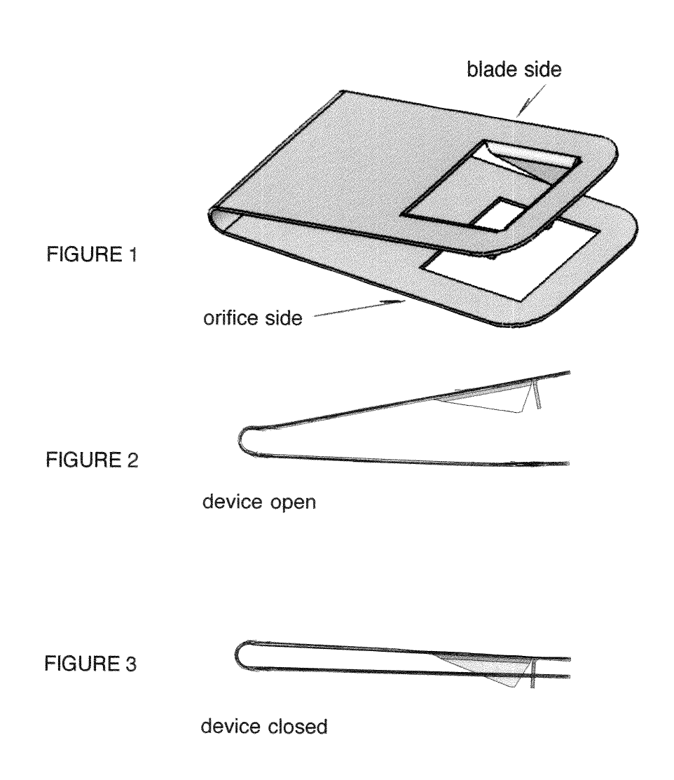

The puncturing device has blades that perforate the backing of a blister that is placed in the orifice of the device shown in FIG. 1. When the blade portion is fully depressed or in the “closed” position as shown in FIG. 3, the blades slice through the backing material of the blister. The perforations in the backing material allow the medication to be easily expelled from the blister by hand.

The “V” shaped device is probably best formed from a strip of metal such as T301 stainless steel of such thickness that the “V” is easily compressed to perforate the backing material. It is possible that certain aluminum materials could be used as long as the device returns to a “V” shape to allow easy use of the device. In any case, the device should be able to be carried in a pocket or purse without fear of oxidation.

Various modifications are possible in the device to accommodate blister shape and size. If a manufacturer of nicotine lozenges in round blister packs wanted to include a puncture device with the product, the blades and orifice would need to be configured to easily accept the blister and adequately puncture the blister.

What is claimed is:

1. a puncturing device comprised of a “V” shaped strip of metal with blades in the top portion able to mesh closely with and enter an orifice in the lower portion that contains a single blister of the medical pack.

2. a device that allows for hygienically disposing of used medicine such as nicotine gum.

3. a device that can be manufactured economically so that it may be made available to the widest range of users.
